(19) United States
(12) Patent Application Publication
(10) Pub. No.: US 2022/0026078 A1
(43) Pub. Date: Jan. 27, 2022

(54) SOLAR WATER HEATER WITH GLAZED FLAT-PLATE COLLECTOR

(71) Applicant: Mourad FATTOUM, Deroua, Berrechid (MA)

(72) Inventor: Mourad FATTOUM, Deroua, Berrechid (MA)

(21) Appl. No.: 17/297,570

(22) PCT Filed: Nov. 28, 2019
(86) PCT No.: PCT/MA2019/000012

§ 371 Date: May 27, 2021

(30) Foreign Application Priority Data
Nov. 28, 2018 (MA) 44035

(51) Int. Cl. F24D 17/00; F24S 10/70; F24S 10/90; F24S 23/77; F24S 60/30

(52) U.S. Cl. CPC F24D 17/0021; F24S 10/70; F24S 60/30; F24S 23/77; F24S 10/90

(57) ABSTRACT

The present invention relates to a solar water heater (SWH) for producing hot water for domestic use, said SWH is inspired from the thermosiphon SWH to manufacture an SWH more efficient in winter and in summer. It is made up of two hot water storage tanks (17) (22) mounted in series in order to have an operating temperature as stable as possible, equipped with a guidance system for heating incoming cold water by passing through the collectors before entering the hot water storage tank (25-a) (25-b), a solar collector receiving solar radiation through its twin transparent faces (35) (36), stainless steel sheet mirrors that reflect the solar radiation applied to the collector through its rear transparent face (36) and a low energy consumption integrated circulator for gaining heat by cancelling out load losses that characterize the resistances to the passage of water in the SWH circuit (29).

### FIELD OF THE INVENTION

The present invention relates to an improved solar voter heater (SWH) for producing hot voter for domestic use consisting of glazed flat-plate collector and two tanks.

### BACKGROUND OF THE INVENTION

There are two main types of thermal solar collectors intended for domestic use: glazed flat-plate collector and tubular collector:

In our case, we are dealing with the thermosyphon Solar Water Heater (SWH), the glazed flat-plate collector type (FIG. 1), It is the easiest type: the tank and the collector constitute one single compact unit. Usually the tank is putted above the collector.

Thermosyphon SWH:

In addition to the accessories and the heat back-up systems that constitute it, the thermosyphon solar water heater is mainly made up of two components:

The collector (4): It transforms solar energy into thermal energy.

The hot water tank, storage tank or accumulator (3): Very well insulated, it is the place of energy storage; it contains a sufficient quantity to meet the domestic needs of hot water.

1—Working Principle
Heat exchange between the tank (3) and the collector is carried out by gravity (the density of hot water is lower than cold water). The pressure difference between cold and heat is used as propulsion energy. K is called the “thermosyphon principle”. To operate, the collector (heat generator) must be located below the tank (heat consumer).
For the type of SWH where the tank does not integrate a coil (A—FIG. 1), it is directly the domestic water that circulates and heated inside the collector. Water heated by the collector is lighter than the cold water in the tank located above the collector. By gravity water in the collector rises to tank and water in the tank go down to collector.
Inside the tank, the colder water falls back to the coldest point of the collector circuit leaving room for the hot water heated by the collector.

4. For the other type (B—FIG. 1), the tank incorporates a coil (7), a good thermal conductor, the inlet/outlet of the collector is connected to this coil thus creating a closed loop circuit called the ‘primary circuit’ (6+7) forming a coolant, the coolant is heated by the collector and therefore less dense, naturally rises towards the coil of the storage tank placed above the collector then exchanges heat by conduction with the water stored in the tank then cools down to the collector and the cycle is repeated again.

2—Thermosyphon SWH Collector Technologies

The collector components are:

The Cover (10): The cover or glazing is the element through which the maximum energy exchange takes place, it must therefore be transparent to allow solar radiation to pass through, which is transformed into heat in the absorber. The latter, taking into account the temperatures reached, radiate in the infrared range, the cover must be opaque to these radiations and must therefore reflect them towards the absorber. The most suited material that exists in the market that allows these conditions to be achieved is glass. The convective exchanges between the absorber and the cover vary with the distance between them. There are three types of glass used as cover for the SWH: Conventional glass, prism glass, glass with anti-reflective layers.

The absorber (11): This is the part of the system which converts solar into thermal energy, it plays a very important role for the performance of a collector. K transforms solar incoming radiation (5) into heat and transmits it into heat to the coolant. Usually it is made of a metal sheet, its main qualities are: Absorption factor as close as possible to unity, infrared emissivity as low as possible, good thermal conductivity (Tabl). The sheet is covered with a conductive black paint (15) because of its physical property which allows total absorption, the surface of the paint must be irregular to reflect unabsorbed radiation towards the absorber.

| Material | thermal conductivity (Wm − 1) | Temperature(K) |
|---|---|---|
| Pure Aluminum | 40 | 293 |
| Pure Copper | 386 | 279 |
| Air | 0.026 | 293 |
| Glass | 1.2~1.4 (96% SiO2) | 293 |

The insulator (12): The insulator role is to maintain the high temperature reached by the absorber and to prevent heat loss through the back and sides of the collector, the insulation optimizes the efficiency of the collector, it allows the maximum amount of heat collected to be transferred to the coolant. It is generally opaque to visible and infrared radiation.

### SUMMARY OF INVENTION

The invention consists in manufacturing a SWH more efficient and more effective, in winter as in summer by taking inspiration from the thermosyphon SWH. The improvement to be made to this type of SWH consists in meeting the following constraints:

1—Constraints

a—The hot water temperature is reduced during the winter period from October to March where the duration of daylight is reduced due to the natural movement of the earth around the sun and the clouds that cover the sky with a random way. The influence on the efficiency of the installation becomes more important when clouds blocks solar radiation at times when it is in normal radius to it during the day, the period during which the maxi mum heat transfer takes place between the collector and the hot water storage tank, the expected 50° C. sufficient to satisfy a comfortable need for hot water is not reached and the use of alternative energy (back-up system) increases then the energy consumption bill intended for the production of domestic hot water increases.

b—During the winter, the very low temperature of the input cold water (less than 10° C.) to the tank that replaces the used hot water, cools down rapidly stored hot water before reaching the full need for use (a shower for example).

c—The operating principle of the thermosyphon is based on the Archimedean thrust which can be written approximately, depending on the temperature and the characteristics of the coolant as follows: B=ρ0β(T−T0)g

With: B: Archimedean thrust force, ρ0: density at equilibrium, β: Coefficient of expansion, T: leaving fluid temperature, T0: return fluid temperature, g: Gravity.

This force generates a waterpower P equal to: P=H×(Mfr−Mfd)

With P: water power available, H: height difference in meters between the axis of the collector and the axis of the SWH tank, Mfr: mass of the fluid at the lowest temperature (collector inlet), Mfd: mass of the fluid at the highest temperature (collector outlet).

In order to have a circulation of the heat transfer fluid, the waterpower P must be greater than the pressure drop ΔP, which can be written in the following form: ΔP=½(K1+K2)ρVQ²

With: K1et K2: are respectively, linear pressure loss coefficient and singular pressure loss coefficient, they depend on the accessories, connections of the installation as well as the dynamics of the fluid inside the installation, VQ: Flow rate.

Thus, for a given collector, the flow rate of the heat transfer fluid depends on the quantity of heat applied to the collector and the temperature gradient between the collector outlet and the tank outlet to the collector. AP is the price to pay for transporting thermal energy from the collector to the tank, it is materialized with a loss of heat during transport, so the temperature of the heat transfer fluid on the tank is lower than its temperature on the collector.

The pressure drops characterize the resistance to the circulation of water in the circuit. The resistance to flow is caused by the length of the pipes and crashes in his way, such as elbows, connection of pipes of different sections or the presence of various adjustment or safety accessories. If the pressure drops are too great, the water is braked and may even no longer circulate. On the other hand, if the pi ping is too large, the water circulates freely, but too slowly and the efficiency is less good.

On a cloudy day when the sun, frequently, only appears for a few minutes and before the next cloud arrives, it increases the temperature at the output of the collector to a value suitable for use but not high enough to ensure the flow towards the tank (or flow very little). The heat does not reach the tank and remains trapped in the collector, the temperature of the latter decreases when radiation disappear by the appearance with new clouds and at the end the expected temperature of the tank is not reached.

2—Structure of the Invention and Manufacturing Process

We chose the thermosyphon SWH because of its simplicity, its cheaper installation cost compared to other types and its adaptation to sunny countries. It must take into account the constraints already mentioned before to achieve energy efficiency better than the current one both in summer and winter and reduce as much as possible the use of non-green alternative energy to meet the domestic need in hot water.

2-1—Schematic Diagram (FIG. 3)

2-1-a—Operating Principle

The operating principle is the same as a thermosiphon SWH described previously, to which components have been added to meet the constraints already mentioned.
The collector coil (20) is mounted in series to ensure a single and integral passage of the domestic cold water from inlet (28) to outlet of the collector (19) to the first storage tank (17).
When hot water is called for use, cold water (26) which replaces the hot water (21) drawn from the second tank (22) enters the system through the passing direction of the non-return valve (25-b) and blocked by the second non-return valve (25-a) in order to force it to pass through the collector (20) before reaching the first tank (17). In daylight this technique allows to reduce considerably (about 60%) the drop in hot water temperature of the tank caused by the entry of cold water into the latter in comparison with a direct entry of cold water into the tank without passing through the collector, since the cold water in its passage is heated by the collector before reaching the tank.
Still with the aim of reducing the drop in hot water temperature in the tank caused by the entry of cold water during use, it was thought to separate the storage capacity into two tanks instead of just one and connected them in series (17) (22), the water to be heated by the collector (20) is drawn from the second tank (22), then discharged after heating, by the passage through the collector, in the first tank (17), hottest water is naturally placed by gravity in the upper part of the tank (23) and the less hot (24) is placed in the lower part, thereby the water drawn from the second tank (22) for use or a heating by the collector (20) is replaced through a tubular connection (19) by hot water from the first tank (23) (17) located in the upper part, so the temperature drop only affects the first tank (17)), the second tank (22) meanwhile and always supplied by the hottest water from the first tank (17). With this method, the temperature of the second tank which supplies the domestic hot water network remains practically the same even after use, sometimes increases if the temperature of the first tank (17) is sufficiently higher than the second (22).

2-1—b The Collector
The absorber (FIG. 4): The absorber is made up of two components: the tubular circuit (32) and the absorbent surface (30).
   The tubular circuit (32): It is the intermediary between the sanitary water to be heated and the absorber, it consists of a round sanitary copper tube of 12 mm diameter, its length depends on the effective collector absorbent surface, sufficiently rigid to withstand the high pressure of around 7 bars, bent with a serpentine shape, it also has very good thermal conductivity better than Aluminum (Tabl).
   The absorbent surface (30): Constructed of a thin sheet of aluminum, which has been bent along its length (31) so that coil is housed in the bends. Aluminum has very good thermal conductivity (Tabl) and it is cheaper than copper and available on the market.
   The connection between tubular coil and absorbent surface: Since the heat transfer from the absorber to the sanitary water to be heated is proportional to the contact surface, so instead of carrying it out with laser welding (often expensive) thus ensuring just thin lines contact between tubular circuit and absorbent surface, it was thought to ensure it by a surface connection by bending the aluminum sheet in such a way that the tubular coil is housed in the sheet (FIG. 4). The more the curvatures of the aluminum sheet and the tubular circuit are aligned the greater are the contact surfaces, more the depth of the curvatures increases, more the contact surfaces increases, better is the heat transfer from the absorber to the sanitary water. The circuit is fixed to the sheet metal with bolts and iron wires (33), good tightening allows good adhesion, resulting in better heat transfer.—The primary frame (FIG. 5): The primary frame of the absorber (34) is made of wood. We chose wood because it is a good and rigid insulator, it will ensure the lateral insulation of the collector and prevent the transfer of heat with the environment in addition to the assembly of glazes and absorber. The wooden planks are cut and assembled as shown in the figure (FIG. 4). The absorber (coil+absorbent surface+primary frame) is then painted with a matt black paint to ensure maximum radiation absorption and minimum reflection.
The glazing: In winter, with the frequent cloudy passage and the reduced time of daylight over the 24 hours day (FIG. 6) considerably weakens the power of solar radiation, in addiction the lower temperature of the cold sanitary water, those constraints can only have a negative influence on the efficiency of the SWH. As a solution we thought to increase solar radiation hitting the collector. So the collector will be double glazed, front face (35) (facing the sun) and rear face (36). The rear face, instead of being opaque, insulating and passive, in the case of a conventional flat panel collector, it will therefore be transparent insulating and active, receiving energy in the form of solar radiation.

The insulation is ensured with a very good joint and the air layer, which separates the glazing and the absorber, the air with its thermal conductivity remains a good insulator (Tab2).

For the glazing on the front face (facing the sun) of the collector, it consists of glass. The rear face glazing is made of plastic, which is lightweight compared to conventional glass, with the following characteristics: transparent, a poor thermal conductor, withstands ultraviolet rays and high temperature. Together the two glazes are jointed and glued to the primary frame, made of wood, by silicon, after mounting the absorber on it.
Secondary framing (FIG. 8): The collector is then framed with a U-shaped frame (37), made from 1.5 mm thick aluminum sheet fixed to the primary frame to give an aesthetic appearance, add more sealing and rigidity to the collector and prevent rusting.

2-1-c Domestic hot water storage tank: The domestic hot water storage tank consists of two commercial electric water heater tanks of total volume depending on the installation, mounted in series (17-22 FIG. 3). Those tanks are intended for domestic use and they are already equipped with electrical water heater which will be used in our case as a back-up system.

2-1-d System support: The system support must be hard enough to support the total weight of all components of the system consisting of mirrors and two tanks loaded and must offer the possibility of depositing and fixing the various components. Our choice therefore falls on the aluminum angle 30*30 mm width, 3 mm thickness, the support (FIG. 7) consists of two sub-supports, the first (38) is used to install the tanks and the mirrors reflectors (40), the second (39) to install the collector and the recovery mirrors (41).

2-1-e Mirrors: In winter, many interns influence the efficiency of the SWH, including the shortest day length of the year (reduced daylight), the longest night time (maximum heat dissipation towards the ambient during the night), a very low ambient temperature which tends to cool down the collector, very cold sanitary water which requires more energy to heat it by the collector, cold wind which also tends to cool down the collector. With those conditions, it becomes difficult to achieve an adequate hot water temperature for use, hence the useful ness of using mirrors which will collect more solar radiation to apply to the collector and thus increase the energy absorbed by the latter, then transferred to the water to be heated. We chose the stainless steel sheet as a mirror because it's handy, resistive to corrosion, mechanical shocks and weather change throughout the year Compared to a conventional mirror, it's reflective to radiation is about 70K, weight less and can be easily attached to the system support.

Mirrors (40) (41) are fixed to the support of the system so that the reflected radiations (43) strike on the rear glazed face of the collector with a maximum radiation during the winter period in order to get almost the same efficiency as in summer. Positions and the angles of the mirrors on the system support take into account the apparent path of the sun relative to the earth along the year and position of the collector. The collector may be fixed manually in two positions, one during the summer period (FIG. 8-E), the other during the winter (FIG. 8-F). Fora given geographical point, we will need two parameters, Azimuth and Elevation (Tab2/FIG. 12). With simulation software, we simulated the angle of solar radiation for each day of the year and thus obtain the fixed and suited positions and angles of the various mirrors which allow a reflection of the solar radiation that falls on the rear glazed surface of the collector (from 9:00 a.m. to 5:00 p.m.) depending on its two positions (one during the summer period (FIG. 8-E), the other during the winter period (FIG. 8-F)), so that radiation is maximum during the winter period. The more mirrors are added, the more the temperature of the collector is increased, the better the efficiency of the SWH is.

| | |
|---|---|
| Date: | Jan. 1, 2018 |
| coordinates: | 34.2260172, −5.7129164 |
| localization: | Sidi Kacem, Morocco |

| Time | Elevation | Azimuth |
|---|---|---|
| 09:00:00 | 26.1 | 92.94 |
| 10:00:00 | 38.37 | 102.48 |
| 11:00:00 | 50.12 | 114.84 |
| 12:00:00 | 60.42 | 133.41 |
| 13:00:00 | 67.03 | 163.5 |
| 14:00:00 | 66.48 | 201.23 |
| 15:00:00 | 59.17 | 229.54 |
| 16:00:00 | 48.57 | 246.97 |
| 17:00:00 | 36.71 | 258.8 |

2-1-f The Circulator

Located on the lower part of the installation (29), mounted in a closed loop with the installation circuit (collector+tanks), it cancels out the thermal energy required to transport hot water from the collector to tanks by thermosiphon allowing better energy gain and SWH efficiency. There are circulators on the market that consume low energy 10-20 Watt, supplied with 12 Volt (with a photovoltaic solar panel or by home supply or with a battery), can deliver up to 11 1/min and withstand a pressure up to 10 bar and a temperature of 100° C. (FIG. 10), perfect for our application.

This circulator needs two temperature sensors and an electrical circuit which will control water circulation in the SWH, all of those components could be integrated in the collector.

Circuit diagram: shown in figure (FIG. 11)

Operating principle: The circuit comprises two temperature sensors Dl (FIG. 11) placed inside the second tank (22) to measure the temperature T1 of sanitary water for use contained on the second tank and D2 (FIG. 11) in the middle of the collector, to measure the average temperature T2 of the water to be heated with the collector. Every minute the microcontroller (FIG. 11) reads the two temperature values and compares them, if T1>T2+6° C. the microcontroller sends a command that switches the transistor Q1 (FIG. 11) to let the electric current pass through the circulator, this latter starts up and begins to transport the water heated by the collector to the tank, if not the circulator is stopped.

### BRIEF DESCRIPTION OF THE DRAWINGS

1—Sanitary cold water inlet
2—Sanitary hot water outlet
3—Hot water storage tank
4—Collector
5—Solar radiation
6—Collector coil
7—Tank Coil
9—Joint
8—Collector inlet
10—Glazing
11—Absorber
12—Insulation
13—Metal frame
14—Conductive thermal transfer.
15—Conductive black paint
16—Laser welding
17—First hot water storage tank
18—Hot water connection link of the first tank with the second tank
19—Col lector outlet to the first tank
20—Glazed flat-plate collector
21—Outlet for domestic use
22—Second hot water storage tank
23—Hot water position at thermal equilibrium
24—Cold water position at thermal equilibrium
25-a—Non-return valve
25-b—Non-return valve
26—Sanitary cold waterinlet
27—Second tank outlet to be heated by the collector
28—Collector inlet
29—Circulator
30—Absorber
31—Tubular shape curves
32—Copper coil
33—Coil/absorber fixation with wire and screw nut
34—Primary wooden frame
35—Glazing front face right to the sun with glass
36—Rear glazing in plastic
37—Secondary aluminum frame
38—Direct reflection mirrors and tank support
39—Recovery mirror and collector support
40—Direct reflection mirrors
41—Recovery mirror
42—Collector
43—Solar radiation
FIG. 1: Thermosyphon glazed flat-plate SWH types and its various components
FIG. 1-A: Direct domestic water circulation SWH with tickelmann coil assembly.
FIG. 1-B: SWH with an integrated coil in tank and ‘S’ coil in collector.
FIG. 2: Thermosyphon glazed flat-plate SWH collector components
FIG. 3: Schematic diagram of the improved thermosyphon glazed flat-plate SWH
FIG. 4: collector absorber and primary framing of the improved SWH.
FIG. 5: Sun path and day length of the city of Nouaceur in summer and in winter
FIG. 6: Glazing and secondary aluminum framing of the improved thermosyphon glazed flat-plate SWH.
FIG. 7: Components Sub-supports of the improved thermosyphon glazed flat-plate SWH.
FIG. 8: Mirrors positions and angles fixation of the improved thermosyphon glazed flat-plate SWH by season.
FIG. 8-E—Direct and reflective (relatively to mirrors angles) solar radiation, city of Nouaceur on Jun. 25, 2019 at 2:00 p.m. GMT+1
FIG. 8-F—Direct and reflective (relatively to mirrors angles) solar radiation, city of Nouaceur on Jan. 1, 2019 at 2:00 p.m. GMT+1
FIG. 9: Azimuth and Elevation, parameters used to locate sun position in relation to the earth at a given place and time of year
FIG. 10: Circulator used to transport hot water to the SWH tank.
FIG. 11: Electrical circuit control ling the improved thermosyphon glazed flat-plate SWH.
FIG. 12: Overview of the improved thermosyphon glazed flat-plate SWH.

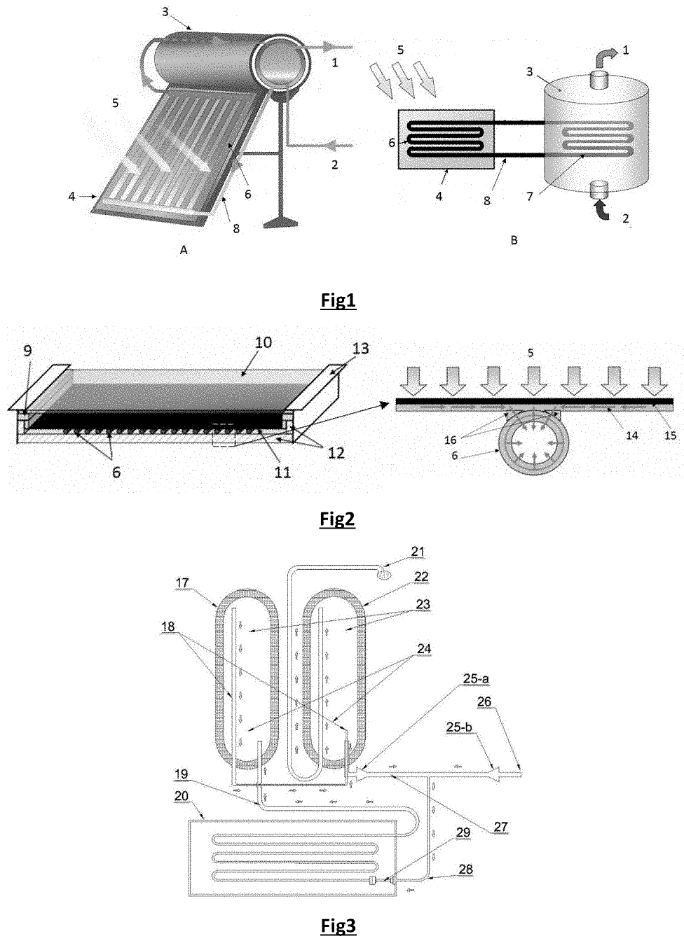

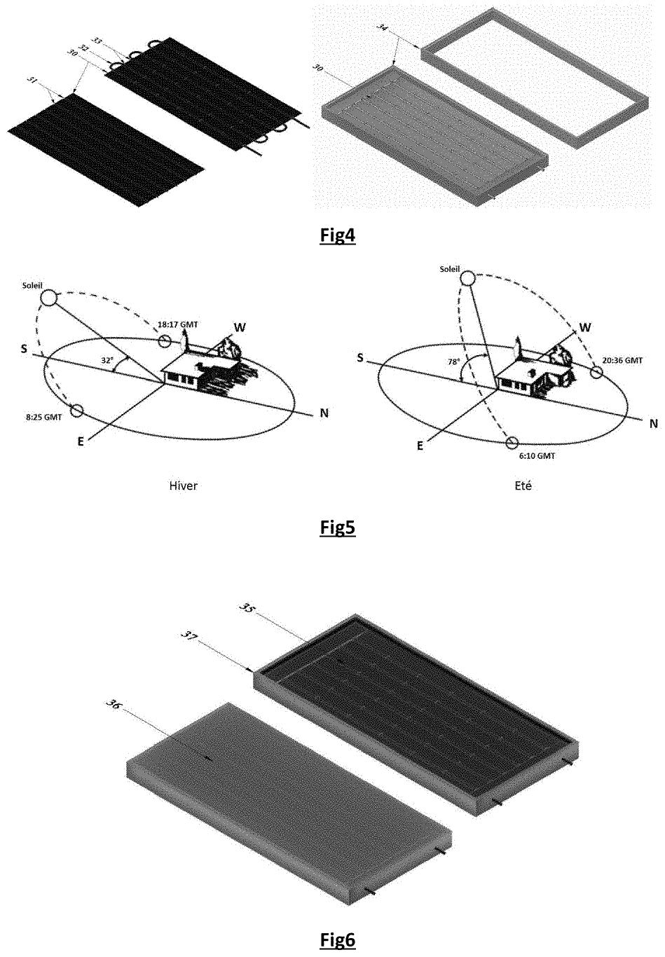

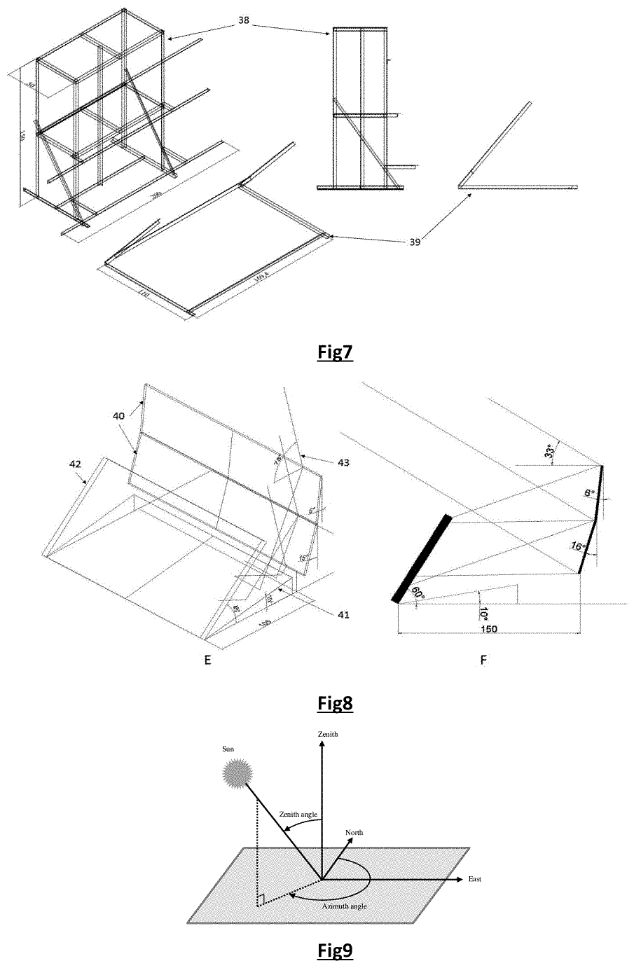

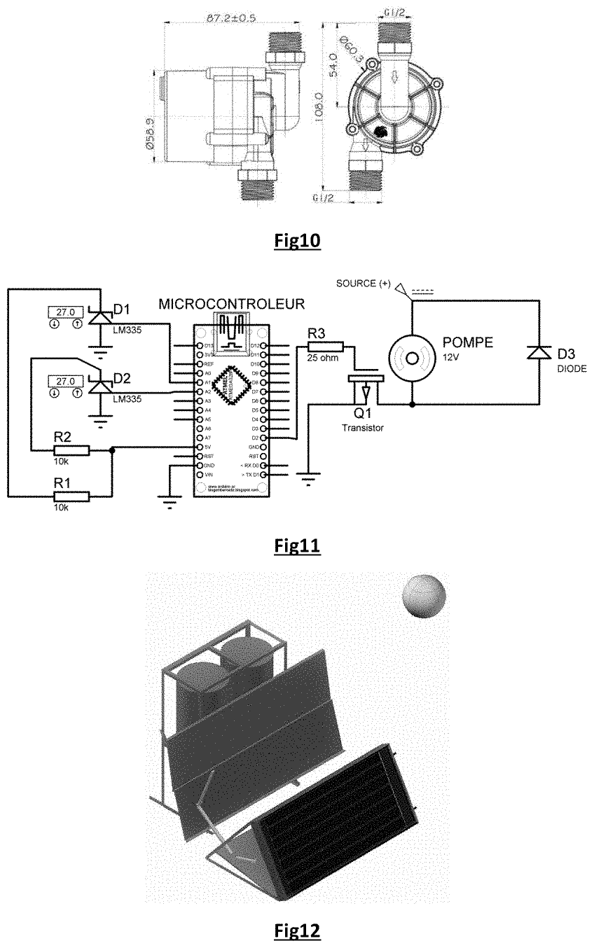

1. Solar water heater (SWH) is used to heat water by solar energy for domestic use containing:
A domestic hot water storage part consisting of two storage tanks mounted in series (17) (18) (22) instead of a single tank (commonly used), to ensure the stability of the hot water temperature during the use, the hot water leaving the collector (19) enters the first tank (17) through its ‘cold water inlet’, the second tank (22) is supplied with water by the ‘hot water outlet’ of the first tank (18), the ‘hot water outlet’ of the second tank (21) is reserved for use. The collector (20) is supplied with cold water to be heated by the ‘cold water inlet’ (27) of the second tank.
A heating part consisting of a solar collector (20) mounted in series in a closed loop with the two storage tanks, the collector is glazed in his two faces (35) (36), front face towards the sun glazed with glass (35) and back side with resistive and transparent plastic (36) to receive more solar radiation on the same absorbing surface and thus increase its temperature quickly and therefore faster water heating with less absorbing surface.
A stainless steel sheet mirrors (40) (41) fixed on the system support (FIG. 7) to radiate the rear face of the collector, the fixed position and angle of the mirrors take into account position and angle of the collector (winter and summer position) and the relative rotation of the sun around the earth during the day and along the days of the year so that the radiation applied to the rear face of the collector is maximum during winter.
A low energy consumption circulator integrated into the collector for gaining heat by cancelling out load losses that characterize the resistances to the passage of water in the SWH circuit (29)
A guidance system to heat incoming cold water by passing through the collector before entering the storage tank (25-a) (25-b) to maintain the heat of water inside it.
A support where the system (tanks+collector+mirrors) are fixed (FIG. 7).

2. Solar water heater according to claim 1, wherein the two tanks (17) (22) are mounted in series and connected in closed loop with the SWH circuit (FIG. 3), the second tank supplied by the hottest water of the first tank located in its upper part (17) (23) allowing a more stable supply of hot water for use.

3. Solar water heater according to claim 1, wherein the solar collector is characterized by an absorbing surface consisting of a thin sheet of aluminum bent along its length (31) such that the tubular circuit (32) is housed in the latter and that the connection between the absorbing surface and the tubular circuit is ensured by housing and fixing with iron wires and screw nut (33).

4. Solar water heater according to claim 3, wherein the solar collector is characterized by a twin transparent faces radiation receivers (35) (36) on the same absorbing surface, front face direction of the sun (35) is glazed with glass and the rear face (36) with resistive and transparent plastic.

5. Solar water heater according to claim 1, wherein a stainless steel sheet mirrors fixed to the support of the system to collect and reflect the radiation towards the rear transparent face of the collector (36).

6. Solar water heater according to claim 1, wherein a low energy consumption circulator is integrated in the collector (29), it plays a dual role, on one hand it ensures the circulation of hot water between the collector, the first tank and the second tank, on the other hand, it saves thermal energy by canceling the pressure drops that characterize the resistance to the passage of water in the water heater circuit of SWH.

7. Solar water heater according to claim 6, wherein the circulator is controlled by an electrical circuit consisting mainly of a microcontroller, two temperature sensors and a transistor (FIG. 11) to manage heated water between storage tanks and the collector, when the temperature in the collector is above the temperature of the second storage tank the circulator is actioned or else it is stopped.

8. Solar water heater according to claim 1, wherein the input water (26) to the SWH (often cold water) that replace the output hot water (in case of domestic use) is characterized by the passage through the collector for heating before entering the tanks (where water is thermally insulated) instead of entering directly to the tanks (commonly used), this guidance system is provided by the assembly of the two non-return valves (25-a) (25-b) and is intended to maintain the temperature of the water in the tanks in case of use during the presence of the sun.

9. Solar water heater according to claim 1, wherein the support serving for the installation of the various components of the SWH (tanks+collector+mirrors) is consisting of two separated sub-support made with Aluminum Angle, one is used to fixe tanks and mirrors and the other to fixe collector, giving more flexibility to adjust manually and easily the collector position in order to get radiation into his back side permanently along the days of the year (FIG. 7).
